(19) United States
(12) Patent Application Publication
(10) Pub. No.: US 2014/0258129 A1
(43) Pub. Date: Sep. 11, 2014

(54) METHOD, APPARATUS AND SYSTEM FOR ESTABLISHING A SECURE COMMUNICATIONS SESSION

(71) Applicants: DAVID EYES, SANTA CRUZ, CA (US); MATT PETERSON, LINDON, UT (US)

(72) Inventors: DAVID EYES, SANTA CRUZ, CA (US); MATT PETERSON, LINDON, UT (US)

(21) Appl. No.: 14/195,623

(22) Filed: Mar. 3, 2014

Related U.S. Application Data
(60) Provisional application No. 61/772,205, filed on Mar. 4, 2013.

(51) Int. Cl. G06Q 30/02

(52) U.S. Cl. CPC G06Q 30/0241; G06Q 2220/00
USPC 705/50

(57) ABSTRACT

A system and method are provided for establishing a secure communication session de novo. A first device and a second device are enabled with two separate and unconnected communications channels. The first channel extends to a service provider server (“server”) and preferably the Internet. The second channel may be formed by the first device and the second device transferring information by light, sound or vibration. The first device and the server communicate a session identifier via the first channel. The first device communicates the session identifier and optionally an encryption key and other information to the first device via the second channel. The second device transmits a message with an encrypted payload to the server referencing the session identifier via the first channel. The message is delivered to the first device by reference to the session identifier, either automatically or by a request message delivered to the server.

### CO-PENDING APPLICATION

The present Nonprovisional Patent application is a Continuation Application of U.S. Provisional Patent Application Ser. No. 61/772,205, titled “Ad Hoc Secure Session Binding of Networked Computing Devices through Out of Band Encoding of Session Keys and Context to Enable Encryption/Decryption of Secure Messages” and filed on Mar. 4, 2013. The present Nonprovisional Patent Application claims the priority date of Provisional Patent Application Ser. No. 61/772,205. Furthermore, Provisional Patent Application Ser. No. 61/772,205 is hereby incorporated into the present Nonprovisional Patent Application in its entirety and for all purposes.

### FIELD OF THE INVENTION

The present invention relates generally to enabling secure electronic communications. More particularly, the present invention relates to enabling parties, persons and/or entities to selectively communicate by means of encrypted messaging via an electronics communications network.

### BACKGROUND OF THE INVENTION

The use of electronic messaging has become a routine aspect of commerce and social interaction to many if not most residents of the more economically dynamic nations. Along with this reliance on electronic messaging, a significant need to establish secure transmission channels by private parties, entities and persons has dramatically increased. Much of the prior art attempts to provide secure communications by application of encryption keys methods wherein a particular encryption key is preferably known to only a self-selected pair of parties, persons and/or entities whom wish to communicate with each other via an electronics communications network and without effective interception and decryption of their messages by any third party. Yet these prior art systems and methods fail to optimally provide a method for an encryption key to be provided by a first party to a second party without relying upon previous communications interaction. This lapse in the prior art is particularly felt today in that it is becoming increasingly common for parties, persons and/or to desire, or be directed to, establish secure communications without requiring a previous transference of an encryption key through an electronics communications network, as such a communication if intercepted could result in a misuse of the encryption key.

There is therefore a growing and long-felt need to provide systems and methods that enable secure communications between two parties via an electronics communication network, e.g., the Internet, a computer network and a telephony network, while avoiding communicating an encryption key via the same or other electronics communication network.

### SUMMARY OF THE INVENTION

Towards this object and other objects of the present invention that will be made obvious in light of the present disclosure, a method and system are provided that enable a network-enabled communications device to receive a session identifier and optionally an encryption key and/or other information via a communications channel that is isolated from another network-based communications channel and to utilize these data in providing securely encrypted message delivery between them. This may be accomplished between any appropriately configured devices on an “ad hoc” basis and without prior foreknowledge of either of the other.

The method of the present invention (hereinafter, “the invented method”) optionally applies dual-channel communications between a session advertising system and a session binding system wherein a first channel of bi-directional communications preferably comprising an electronic communications network may be formed between the session advertising system and the session binding system, as mediated by a service provider server or system, and a second alternate communications channel that enables at least uni-directional communication of a session identifier and optionally an encryption key and/or contextual information and other information between the session advertising system and the session binding system. In accordance with the invented method, the second channel preferably does not require communication via, nor comprise, the electronic communications network of the first channel.

In one alternate preferred embodiment of the invented method, an advertising system may render quick response code image, known as a QR code in the art, in a displayed screen of the advertising system, wherein the QR code encodes a unique session identifier and an encryption code. The session binding system may be a digital cellular telephone that is equipped with a digital camera and a QR reader software. The session binding system reads the QR code rendered by the display screen of the advertising system and then applies the encryption key to encrypt a payload. The encrypted payload and the session identifier may then be transmitted in a message from the session binding system to a service provider system via an electronics communications network as mediated by a service provider server or system. The electronics communications network may comprise the Internet and/or one or more wireless communications networks, such as a telephony network. The advertising system may then receive the encrypted payload via the electronics communications network by either (a.) an automated forward of the encrypted payload from the service provider system, or (b.) by requesting a forward of any message received by the service provider system that references the same session identifier that the advertising system rendered in the previous display of the QR code. The advertising system may then apply the same encryption code system rendered in the previous display of the QR code to decrypt the payload received via the electronic communications network. Optionally and additionally, the session binding system may thereafter receive one or more additional encrypted payloads via the electronics communications network by either (a.) an automated forwarding of the encrypted payload from the service provider system that originated from the advertising system, or (b.) by the session binding system requesting a forward of any message received by the service provider system that references the same session identifier that the advertising system rendered in the previous display of the QR code. The advertising system and the session binding system may thereby exchange encrypted payloads that are encrypted by an encryption key that is never available to, nor accessed by any other participant of the electronics communications network, to include the service provider system.

In a first optional aspect of the invented method the session identifier is available to both the session advertising system and a service provider system, wherein the session identifier may be originated and/or allocated by either the session advertising system or the service provider system in various alternate embodiments of the invented system. The session identifier may optionally be communicated between the session advertising system and the service provider system by means of the electronic communications network of the first channel.

In a second optional aspect of the invented method, the session identifier and optionally other information is communicated from the session advertising system and to the session binding system via the second channel, wherein the second channel is preferably established by transfer of information by means of paired signaling modules that are each respectively separately positioned within or communicatively coupled with the session advertising system and the session binding system. The signaling modules may enable communication of information by means of light wave energy, sound wave energy, vibrational energy and/or other suitable communication media known in the art that is exclusive of the first channel.

The other information optionally communicated via the second channel and between the session advertising system and the session binding system may include an encryption key, contextual information, query information, an address of the service provider system, an address of the session advertising system, an address of the session binding system and/or information related to the session advertising system, the session binding system and/or the service provider system.

In a third optional aspect of the invented method, the session binding system may receive a session identifier and an encryption key from the session advertising system. The session binding system may then address an initiating message to the service provider system, wherein the initiating message includes a payload of information, wherein at least a portion of the payload of information may have been encrypted by application by the session binding system of the encryption key received via the second channel. The payload of the initiating message and subsequent electronic messages may include one or more passwords, user identifiers, account identifiers, financial account information, permissions, time-date data, geolocational data, and/or other information.

In yet another optional aspect of the invented method, the session binding system may receive contextual information from the session advertising system and/or the service provider system, wherein the contextual information indicates to the session binding system what information shall be selected by and communicated from the session binding system to the session advertising system via the first channel. The contextual information may optionally be provided to the service provider system by the session advertising system and in a manner that enables transference to the session binding system.

In a still additional optional aspect of the invented method, the service provider system may provide one or more messages containing the session identifier to the session advertising system on an automated basis and/or in response to a request from the session advertising system, whereby messages transmitted via the first channel by the session binding system are delivered to the session advertising system.

### BRIEF DESCRIPTION OF THE DRAWINGS

FIG. 1A is a network diagram of one embodiment of a system for enabling and providing secure communications between electronic systems and communications devices.

FIG. 1B is a block diagram of a variation of channel B of FIG. 1A wherein communication by light wave energy is enabled.

FIG. 1C is a block diagram of a second variation of channel B of FIG. 1A wherein communication by sound wave energy is enabled.

FIG. 1D is a block diagram of a third variation of channel B of FIG. 1A wherein communication by vibrational energy is enabled.

FIG. 2 is a process diagram of a first preferred embodiment of the invented method as enabled by the system of FIG. 1A.

FIG. 3 is a software flowchart of operations of the session advertising system of FIG. 1A in accordance with a second preferred embodiment of the invented method that is in accordance with the process chart of FIG. 2.

FIG. 4 is a software flowchart of operations of the session binding system of FIG. 1A in accordance with the second preferred embodiment of the invented method of FIG. 3.

FIG. 5 is a software flowchart of operations of the service provider system of FIG. 1A in accordance with the second preferred embodiment of the invented method of FIG. 3.

FIG. 6 is a software flowchart of operations of the session advertising system of FIG. 1A in accordance with a third preferred embodiment of the invented method that is in accordance with the process chart of FIG. 2.

FIG. 7 is a software flowchart of operations of the session binding system of FIG. 1A in accordance with the third preferred embodiment of the invented method of FIG. 6.

FIG. 8 is a software flowchart of operations of the service provider system of FIG. 1A in accordance with the third preferred embodiment of the invented method of FIG. 6.

FIG. 9A is a flowchart of operations of the advertising system of FIG. 1A that presents a fourth alternate preferred embodiment of the invented method wherein the advertising system of FIG. 1A generates or allocates a session identifier.

FIG. 9B is a flowchart of additional optional aspects of operations of the server of FIG. 1A in accordance with the fourth alternate preferred embodiment of the invented method of FIG. 9B, wherein the server receives a session identifier from the advertising system of FIG. 1A.

FIG. 10A is a flowchart of operations of the advertising system of FIG. 1A that presents a fifth alternate preferred embodiment of the invented method wherein the advertising system of FIG. 1A transmits contextual information and/or additional data to the server of FIG. 1A.

FIG. 10B is a flowchart of additional optional aspects of operations of the server of FIG. 1A in accordance with the fifth alternate preferred embodiment of the invented method of FIG. 10A, wherein the server receives contextual information and/or additional data from the advertising system of FIG. 1A.

FIG. 10C is a flowchart of additional optional aspects of operations of the user device of FIG. 1A in accordance with the fifth alternate preferred embodiment of the invented method of FIG. 10A, wherein the user device receives contextual information and/or additional data from the server of FIG. 1A.

FIG. 11 is a flowchart of additional optional aspects of operations of the user device of FIG. 1A in accordance with a sixth alternate preferred embodiment of the invented method, wherein the user device may receive and process contextual information and/or additional data from either the service provider server or the advertising system of FIG. 1A.

FIG. 12 is a depiction of a webpage displayed in a display screen of the advertising system of FIG. 1A.

FIG. 13A is a representation of certain informational elements of the exemplary first quick response code image of FIG. 12 displayed in the display screen of the advertising system 110 of FIG. 1A.

FIG. 13B is a representation of an exemplary first context record stored by the session binding system of FIG. 1A.

FIG. 13C is a representation of an exemplary first user message as formatted and transmitted by the session binding system of FIG. 1A.

FIG. 13D is a representation of an exemplary first request message whereby the advertising system of FIG. 1A requests one or more encrypted payloads the service provider system of FIG. 1A that are associated with the exemplary first session identifier of FIG. 1A.

FIG. 13E is a representation of an exemplary first response message whereby the service provider system of FIG. 1A transmits a first payload associated with the exemplary first session identifier of FIG. 1A to a network address of the advertising system of FIG. 1A.

FIG. 13F is a representation of an exemplary first context message whereby the advertising system of FIG. 1A provides the exemplary first context indicator to the service provider system of FIG. 1A.

FIG. 13G is a representation of an exemplary first context request message wherein the session binding system of FIG. 1A requests the first context indicator from the service provider server of FIG. 1A.

FIG. 13H is a representation of an exemplary first context indicator provision message wherein the service provider server of FIG. 1A provides the first context indicator to the session binding system of FIG. 1A.

FIG. 13I is a representation of an exemplary first session record that associates one or more payloads and optionally one or more network addresses with the first session identifier of FIG. 1A.

FIG. 14 is a schematic block diagram of the advertising system of FIG. 1A.

FIG. 15 is a schematic block diagram of the session binding system, or user device of FIG. 1A.

FIG. 16 is a schematic block diagram of the service provider server of FIG. 1A.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

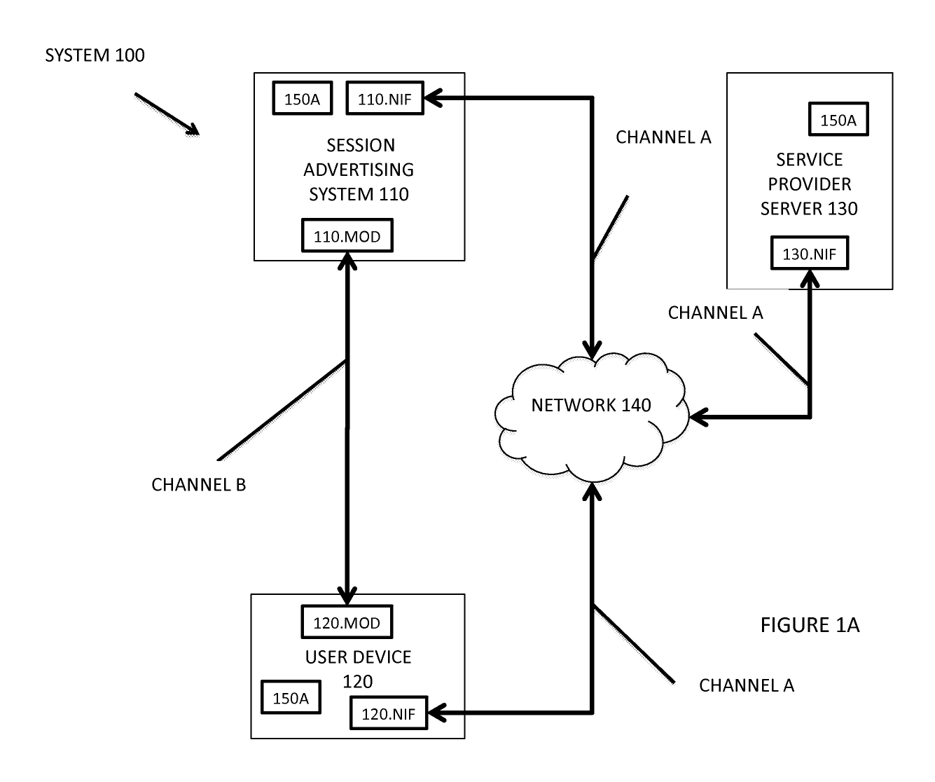

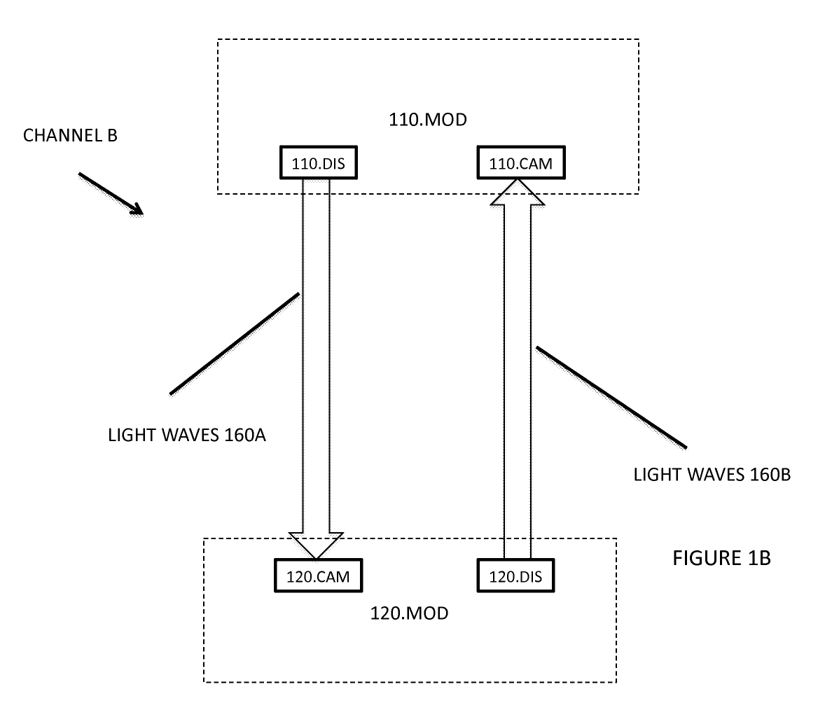

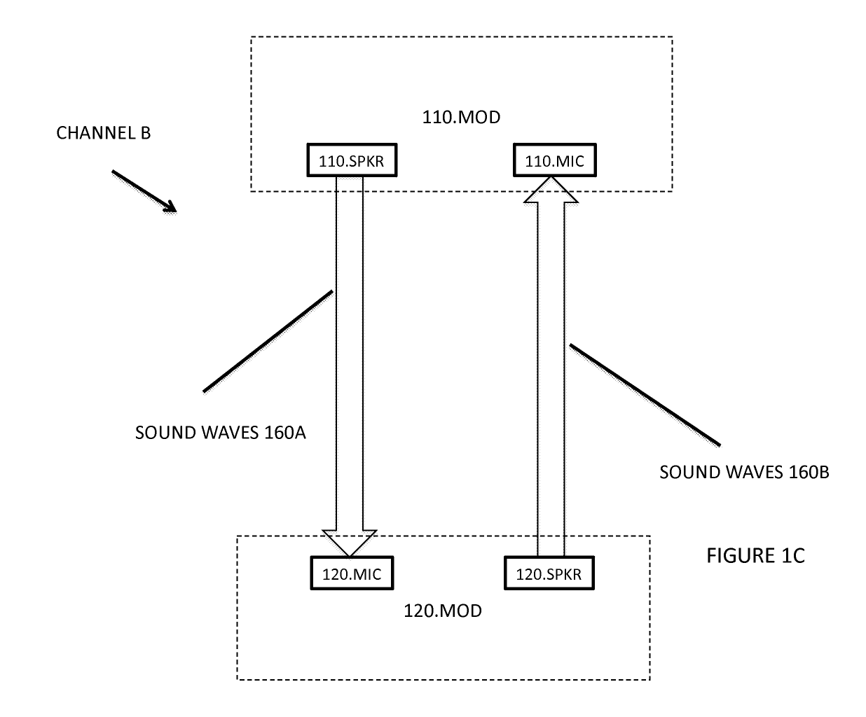

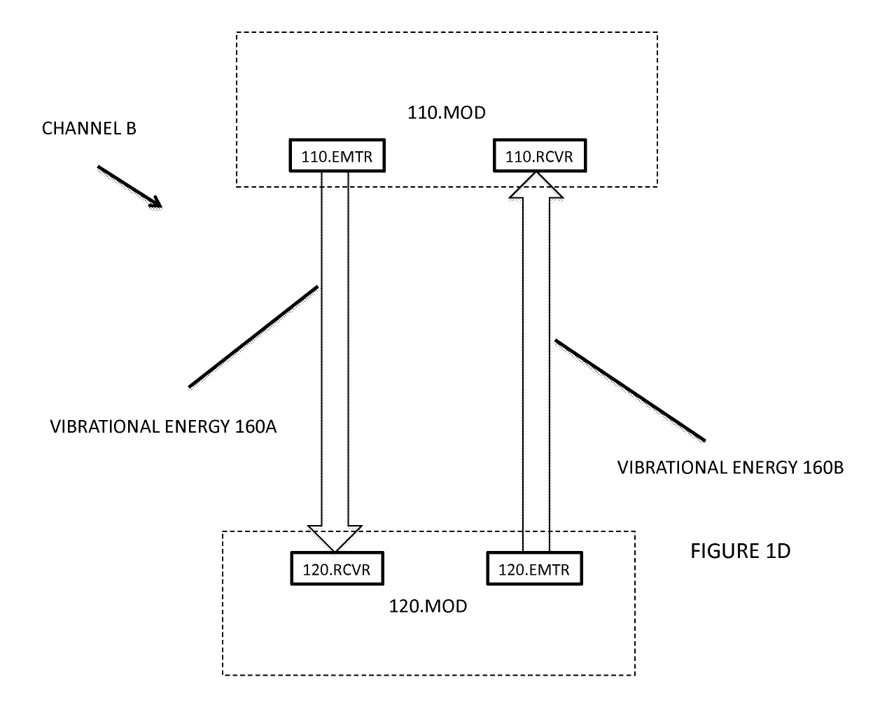

FIG. 1A is a network diagram of one embodiment of a system 100 for enabling and performing secure communications sessions. The system 100 includes a session advertising systems 110, one or more session binding systems 120 (hereinafter, “user devices 120”), a service provider server 130 and an electronics communications network 140. For purposes of illustration, the embodiment of the system 100 shown by FIG. 1 includes a single a session advertising system 110 (hereinafter, “the advertising system 110”) and a single session binding system 120 (hereinafter, “the user device 120”). However, in other embodiments, the system 100 may include additional advertising systems 110, additional user devices 120 and/or additional service provider server 130 (hereinafter “the server 130”). Preferably, any user device 120 is a client device that may optionally pair with any advertising system 110 as elected by a user.

A first communications channel A is established that enables electronic messaging between the system 110, the user device 120 and/or the server 130, wherein channel A further includes some or all of the electronics communications network 140. An advertising system network interface 110.NIF of the advertising system 110 enables the advertising system 110 to bi-directionally communicate with the server 130 via the channel A. A user device interface 120.NIF of the user device 120 enables the user device 120 to bi-directionally communicate with the advertising system 110 and the server 130 via the channel A. A server interface 130.NIF of the server 130 enables the server 130 to bi-directionally communicate with the advertising system 110 and the user device 120 via the channel A.

Each session advertising system 110 is preferably additionally configured with or communicatively coupled with an advertising system signal module 110.MOD and each user device 120 is preferably configured with or communicatively coupled with a device signal module 120.MOD, wherein the advertising system signal modules 110.M and the device signal modules 120.M are adapted to in combination provide and establish a second channel B of communications that is preferably distinguishable from and isolated from the channel A, the server 130, and the electronics communications network 140. The session advertising systems 110 and the user device system are thereby enabled via the channel B to transmit information (a.) from the session advertising systems 110 to one or more the user devices 120, and (b.) optionally, additionally or alternatively, from the one or more user devices 120 to one or more session advertising systems 110. In various alternative preferred embodiments of the present invention, information is transmitted via the channel B by means of light wave, sound wave, and/or vibrational energy transmission, exclusive of the mechanism of Channel A.

The advertising system 110 comprises one or more computing devices that can preferably receive input from a user and can transmit and receive data via the electronics communications network 140 (hereinafter, “the network 140”). For example, the advertising system 110 may be or include a desktop computer, a laptop computer, a smart phone, a personal digital assistant or any other device including computing functionality and data communication capabilities. The advertising system 110 is configured to bi-directionally communicate with the user device 120 and the server 130 via the network 140.

In addition, the user device 120 is configured to bi-directionally communicate with the advertising system 110 and the server 130 via the network 140. The user device 120 is or comprises, in many alternate embodiments of the invented method, a portable communications device, such as the user device 2 may be (a.) an IPHONE™ cellular telephone as marketed by Apple, Inc. of Cupertino, Calif.; (b.) an HTC TITAN II™ cellular telephone as marketed by AT&T, Inc. of Dallas, Tex. and running a WINDOWS 7™ operating system as marketed by Microsoft Corporation of Redmond, Wash.; (c.) a GALAXY NEXUS™ smart phone as marketed by Samsung Group of Seoul, Republic of Korea or and running an ANDROID™; (d.) an IPAD™ tablet computer as marketed by Apple, Inc. of Cupertino, Calif.; and/or (e.) a TOUGHPAD™ tablet computer as marketed by Panasonic Corporation of Kadoma, Osaka, Japan and running an ANDROID™ operating system as marketed by Google, Inc. of Mountain View, Calif.

The network 140 may comprise any combination of the Internet, local area networks and/or wide area networks, using both wired and wireless communication systems.

The server 130 comprises one or more computing devices preferably generating on demand as needed and/or storing a plurality of unique session identifiers 150A-150N. According to various embodiments, the server 130 can be accessed through a wired or wireless network 140 by advertising systems 110 or user devices 120.

In various alternate preferred embodiments of the invented method, the advertising system 110, the user device 120 or the server 130 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; or (e.) other suitable computational system, mobile electronic device, wireless communications device, or electronic communications device known in the art.

In various still alternate preferred embodiments of the invented method, the advertising system 110 or the server 130 may be or comprise (a.) an IPHONE™ cellular telephone as marketed by Apple, Inc. of Cupertino, Calif.; (b.) an HTC TITAN II™ cellular telephone as marketed by AT&T, Inc. of Dallas, Tex. and running a WINDOWS 7™ operating system as marketed by Microsoft Corporation of Redmond, Wash.; (c.) a GALAXY NEXUS™ smart phone as marketed by Samsung Group of Seoul, Republic of Korea or and running an ANDROID™; (d.) an IPAD™ tablet computer as marketed by Apple, Inc. of Cupertino, Calif.; or (e.) a TOUGHPAD™ tablet computer as marketed by Panasonic Corporation of Kadoma, Osaka, Japan and running an ANDROID™ operating system as marketed by Google, Inc. of Mountain View, Calif.

Referring now generally to the Figures and particularly to FIG. 1B, FIG. 1B is a block diagram of a variation of channel B of FIG. 1A wherein communication by light wave energy is enabled. The user device module 120.MOD includes a user device digital camera 120.CAM that detects light wave energy emitted by an advertising system display screen 110.DIS of the advertising system 110, whereby information is transferred via the channel B from the advertising system 120 to the user device 110 by light wave energy transmission. Additionally or alternatively, the advertising system module 110.MOD includes an advertising system digital camera 110.CAM that detects light wave energy emitted by a user device display screen 120.DIS of the user device 120, whereby information is transferred via the channel B from the user device 110 to the advertising system 120 by light wave energy transmission. The user device module 120.MOD and the advertising system module 110.MOD are preferably adapted to communicate in order to effectively accomplish the static or dynamic transmission of information by light wave energy between the user device 120 and the advertising system 110.

Referring now generally to the Figures and particularly to FIG. 1C, FIG. 1C is a block diagram of a second variation of channel B of FIG. 1A wherein communication by sound wave energy is enabled. The user device module 120.MOD includes a user device audio microphone 120.MIC that detects sound wave energy emitted by an advertising system audio speaker 110.SPKR of the advertising system 110, whereby information is transferred via the channel B from the advertising system 120 to the user device 110 by sound wave energy transmission. Additionally or alternatively, the advertising system module 110.MOD includes an advertising system audio microphone 110.MIC that detects sound wave energy emitted by a user device audio speaker 120.SPKR of the user device 120, whereby information is transferred via the channel B from the user device 110 to the advertising system 120 by sound wave energy transmission. The user device module 120.MOD and the advertising system module 110.MOD are preferably adapted to communicate in order to effectively accomplish the dynamic transmission of information by sound wave energy between the user device 120 and the advertising system 110.

Referring now generally to the Figures and particularly to FIG. 1D, FIG. 1D is a block diagram of a third variation of channel B of FIG. 1A wherein communication by vibrational energy is enabled.

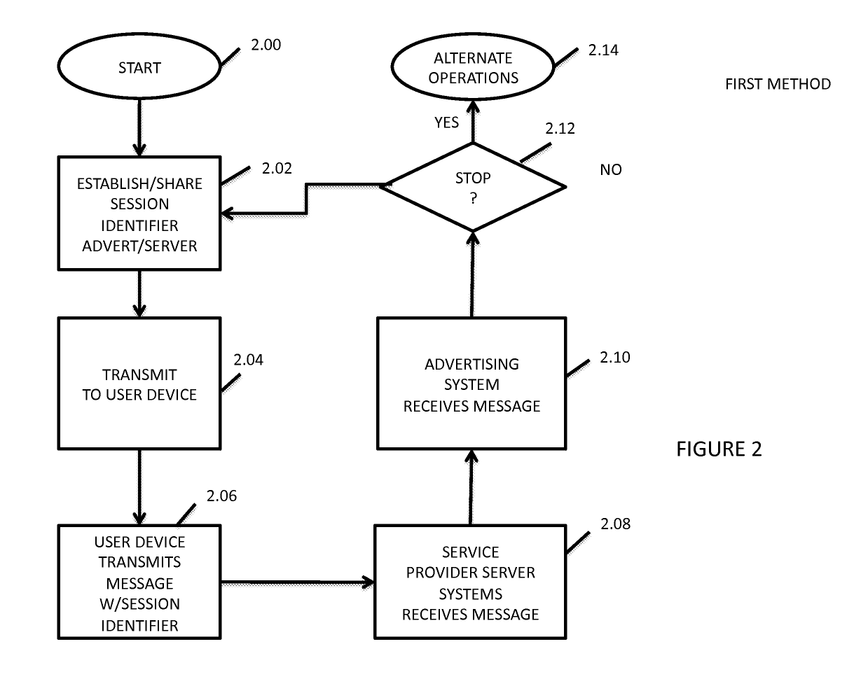

The user device module 120.MOD includes a user device vibrational energy receiver 120.RCVR that detects vibrational energy emitted by an advertising system vibrational energy emitter 110.EMTR of the advertising system 110, whereby information is transferred via the channel B from the advertising system 120 to the user device 110 by sound wave energy transmission. Additionally or alternatively, the advertising system module 110.MOD includes an advertising system vibrational energy receiver 110.RCVR that detects vibrational energy emitted by a user device vibrational energy emitted 120.EMTR of the user device 120, whereby information is transferred via the channel B from the user device 110 to the advertising system 120 by vibrational energy transmission. The user device module 120.MOD and the advertising system module 110.MOD are preferably adapted to communicate in order to effectively accomplish the dynamic transmission of information by vibrational energy between the user device 120 and the advertising system 110. Referring now generally to the Figures and particularly to FIG. 2, FIG. 2 is a flow chart of a first invented method that is enabled by the system 100. In step 2.02 an exemplary first session identifier 150A is allocated by either the advertising system 110 or the server 130 and transmitted from the originating advertising system 110 or the originating server to the non-originating advertising system 110 or server 130 by means of a first channel A that accesses or comprises the network 140. In step 2.04 the exemplary first session identifier 150A is received by the user device 120 as rendered by the advertising system 110. The first session identifier 150A is transmitted by a second communications channel B that is formed by a pair of complementary and tuned communications modules 110.MOD & 120.MOD of the advertising system 110 and the user device 120 respectively.

In step 2.06 the user device 120 transmits an exemplary first message UMSG.01 addressed to the server 130 via the network 140, wherein the exemplary first user message UMSG.01 includes the first session identifier 150A and optionally an exemplary first payload PAY.001 wherein the first payload PAY.01 may be partly or entirely encrypted by the user device 120 prior to transmission to the server 130. It is understood the user device 120 may optionally receive an exemplary first encryption key K.01, an exemplary first contextual indicator CONT.IND.01-CONT.IND.N from the advertising system 110 via the second communications channel B in step 2.04.

The user device 120 optionally (a.) applies the first encryption key K.01 to encrypt the first payload PAY.01; (b.) applies the first contextual indicator CONT.IND.01 to select information to include in the first payload PAY.01 to transmit to the server 130; and/or (c.) includes some or all other information in the first payload PAY.01.

The server 130 receives the first payload PAY.01 in step 2.08 and in step 2.10, either (a.) by an automated process that associates the first session identifier 150A with the advertising system 110, or (b.) upon receipt of a first request message RMSG.01 from the advertising system 110 referencing the first session identifier 150A, forwards all or at least a portion of the first user message UMSG.01 to the advertising system 110. The system 100 determines in step 2.12 whether to initiate another cycle of the loop of steps 2.02 through 2.12, or to proceed on to alternate computational operations of step 2.14. It is understood that from step 2.14 the system 100 may return to step 2.02 as directed by an automated process or by a direction of a human operator.

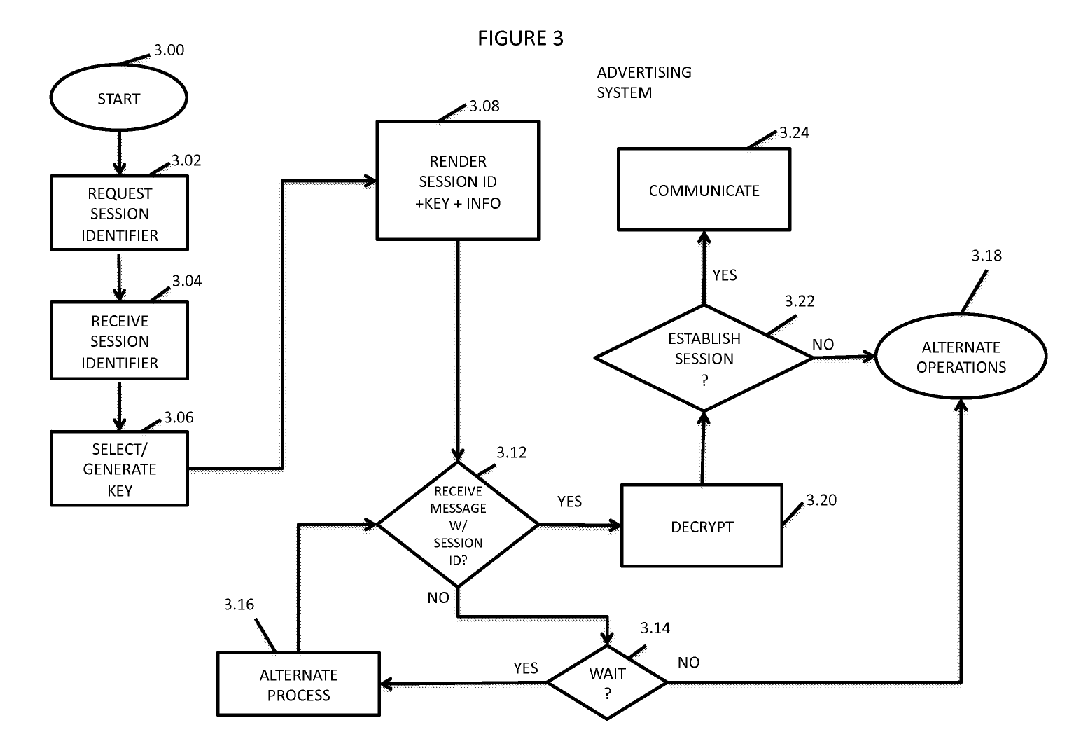

Referring now generally to the Figures and particularly to FIG. 3, FIG. 3 is a flowchart of operations of the advertising system 110 that presents optional aspects of a second preferred embodiment of the invented method (hereinafter, “the second method”). In step 3.02 the advertising system 110 requests one of the session identifiers 150A-150N from the server 130 and receives the first session identifier 150A in a first instantiation of step 3.04. The session 110 selects or generates the first encryption key KEY.01 in optional step 3.06. In optional step 3.08 the advertising system 110 renders the first session identifier 150A and optionally the first key KEY.01, the first contextual indicator CONT.IND.01 and/or other information INFO in step 3.08.

The advertising system 110 determines in step 3.12 whether an associated message AMSG.01 that optionally references the first session identifier 150A, and/or may be decrypted by means of the first key KEY.01, is received via the network 140. The advertising system 110 determines on step 3.14 whether to continue to either (a.) wait for an associated message AMSG.01 and to proceed on to one or more alternate processes of step 3.16, or (b.) proceed to step 3.18 whereby information decrypted from first payload PAY.01 is applied by the advertising system 110 and to cease examining incoming messages from the network 140 for association with the first session identifier 150A and/or the first key KEY.01.

When the advertising system 110 determines in step 3.12 to have received an exemplary associated message AMSG.01 via the network 140, the advertising system 110 proceeds on to optional step 3.20 and to decrypt the first payload PAY.01 of the first associated message AMSG.01. In optional step 3.22 the advertising system 110 determines whether a communication session shall be initiated on the basis of the first payload PAY.01 and/or receipt of the first associated message AMSG.01. When the advertising system 110 determines in step 3.22 that a communication session shall be initiated, the advertising system 110 proceeds on to step 3.24 and initiates a communications session. In the alternative, when the advertising system 110 determines in step 3.22 that a communication session shall not be initiated, the advertising system 110 proceeds on to alternate operations of step 3.18, wherein the contents of the decrypted payload may optionally be utilized in a contextually appropriate manner.

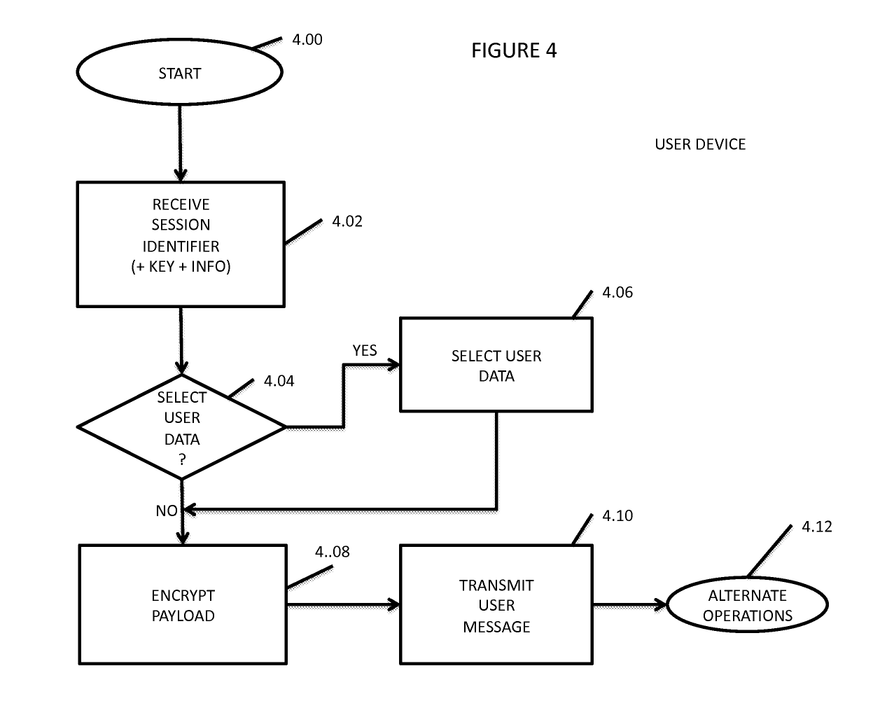

Referring now generally to the Figures and particularly to FIG. 4, FIG. 4 is a flowchart of operations of the user device 120 that presents optional aspects of the second method. In step 4.02 the user device 120 receives the first session identifier 150A via the channel B from the advertising system 110 and optionally receives the first key KEY.01, the first contextual indicator CONT.IND.01. In step 4.04 the first device determines whether to select an exemplary first contextual content record CONT.REC.01 accordance with and reference to the first contextual information INFO.01, and if so determines, selects the data and information of the first contextual content record CONT.REC.01 in step 4.06.

The user device 120 applies the first key KEY.01 to encrypt the first payload PAY.01 in optional step 4.08. The first payload PAY.01 may include some or all of the contents of the first contextual record CONT.REC.01. The user device 120 transmits the first payload PAY.01 to the server 130 in an exemplary first user message UMSG.01 in step 4.10 and proceeds on to alternate operations in step 4.12. It is understood that from step 4.12 the user device 120 may return to step 4.02 as directed by an automated process or by a direction of a human operator.

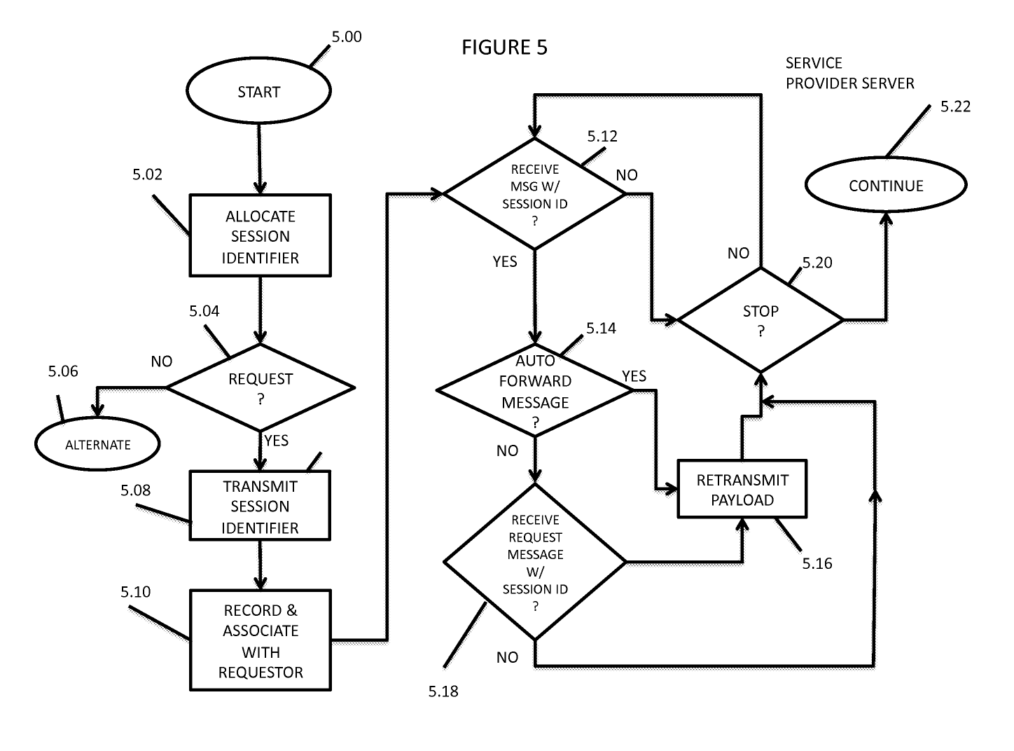

Referring now generally to the Figures and particularly to FIG. 5, FIG. 5 is a flowchart of operations of the server 130 that presents optional aspects of the second method. In step 5.02 the server 130 allocates the first session identifier 150A and determines if the advertising system 110 has requested a session identifier 150A-150N in step 5.04. The server 130 transmits the exemplary first session identifier 150A to the advertising system 110 via the network 140 in step 5.08 and optionally associates the advertising system 110 with the first session identifier 150A in step 5.10. When the server 130 determines in step 5.12 that a user message UMSG.01-UMSG.N containing the first session identifier 150A has been received via the network 140, the server 130 in optional step 5.14 determines whether to automatically transmit some or all of the first payload PAY.01 to the advertising system 110 via the network 140 in step 5.16. In the alternative, the server 110 may determine in step 5.18 to transmit the first payload PAY.01 to the advertising system 110 via the network 140 in response to an exemplary first request message RMSG.01, wherein the first request message RMSG.01 comprises or references the first message identifier 150A.

The server 130 determines in step 5.20 whether to initiate another cycle of the loop of steps 5.02 through 5.20, or to proceed on to alternate computational operations of step 5.22. It is understood that from step 5.22 the server 130 may return to step 5.02 as directed by an automated process or by a direction of a human operator.

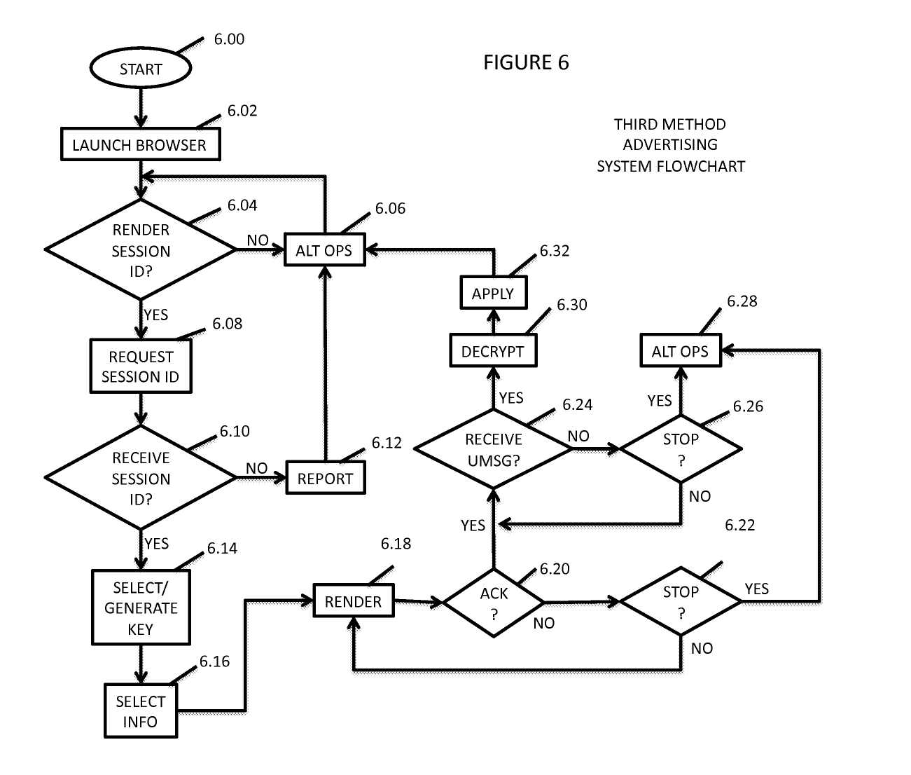

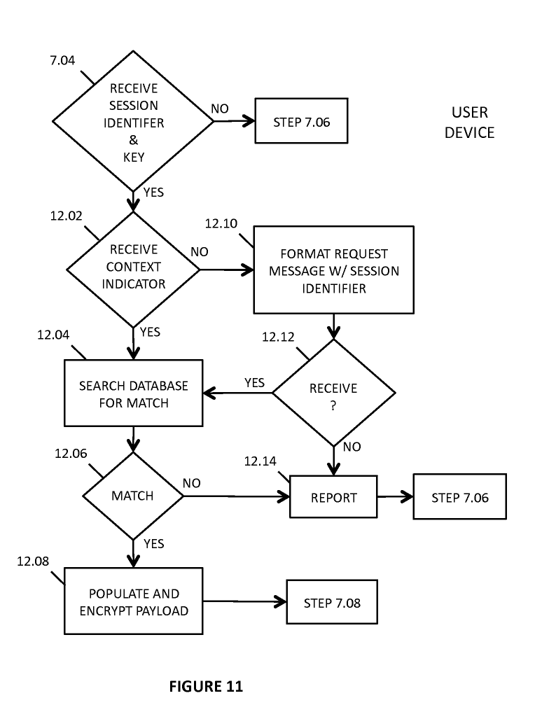

Referring now generally to the Figures and particularly to FIG. 6, FIG. 6 is a flowchart of operations of the advertising system 110 that presents a third alternate preferred embodiment of the invented method (hereinafter, “the third method”). that includes additional optional aspects of the invented method. In step 6.02 the advertising system 110 launches a web browser 110.BRW as directed by a human operator and subsequently renders an exemplary first browser window 600, as presented in FIG. 11. The first browser window 600 includes a service activating button 602 positioned with in a browser control region 604 and additionally a webpage image 606.

In step 6.04 the advertising system 110 detects whether a user selects the service activating button 602 rendered on the display screen 110.DIS of the advertising system 110 within a browser control region 604 of a rendered browser window 606 by the system software 110.5W. When no user selection of the service activating button 602 is detected by the advertising system 110 in step 6.04, the advertising system 110 proceeds on to step 6.06 and to perform alternate computational operations. It is understood that the advertising system 110 may subsequently return to a later instantiation of step 6.04 as directed by the user and/or by an automated process. In the alternative, when a user selection of the service activating button 602 is detected by the advertising system 110 in step 6.04, the advertising system 110 proceeds on to step 6.08 and requests a session identifier 150A-150N from the server 130. It is understood that the advertising system 110 may have received and stored a session identifier 150A-150N previous to the instant execution of step 6.04 that the advertising system 110 will proceed to allocate in step 6.10 and apply in the third method.

When a session identifier 150A-150N is neither received nor allocated by the advertising system 110 in step 6.10, the advertising system 110 proceeds on to step 6.12 to report to the user via the advertising system display screen 110.DIS the failure to receive or allocate a session identifier 150A-150N. In the alternative, when a session identifier 150A-150N is received and allocated in steps 6.06 and step 6.10, the advertising system 110 selects or generates an encryption key KEY.01-KEY.N in step 6.14 and selects an exemplary first contextual indicator CONT.IND.01 associated with the first webpage image 606. The first contextual indicator CONT.IND.01 associated with the first webpage image 606 may be, for example, a universal resource locator of the first webpage image 606, or a reference to a request for a purchase authorization.

The advertising system 110 then generates and renders a QR code 110.QR in step 6.18, wherein the QR code 110.QR includes an encoding of the session identifier 150A-150N allocated in step 6.10, the encryption key KEY.01-KEY.N allocated in step 6.14 and the contextual indicator CONT.IND.01 selected in step 6.16. In optional steps 6.20 and 6.22 the rendering of the QR code 110.QR of step 6.18 is continued the system software 110.SW directs the advertising system 110 to cease rendering the QR code 110.QR and to proceed on to step 6.24 and to perform alternate computational operations.

The advertising system 110 polls the server 130 in step 6.26 to request a forwarding of any message UMSG.01-UMSG.N that references the same session identifier 150A-150N allocated in the previous execution of step 6.10, and if no message UMSG.01-UMSG.N referencing the same session identifier 150A-150N allocated in the previous execution of step 6.10 is received in step 6.26 by the advertising system 110 from the server 130, the advertising system 110 determines in step 6.28 whether to (a.) continue to poll the server 130 for a user message UMSG.01-UMSG.N referencing the same session identifier 150A-150N allocated in the previous execution of step 6.10, or (b.) proceed on to step 6.24 and to perform alternate computational operations.

In the alternative, when a message UMSG.01-UMSG.N referencing the same session identifier 150A-150N allocated in the previous execution of step 6.10 is received and detected by the advertising system 110 in step 6.26, the advertising system 110 proceeds to decrypt an encrypted payload PAY.01-PAY.N of the user message UMSG.01-UMSG.N received in step 6.26 by application of the encryption key KEY.01-KEY.N allocated in the previous execution of step 6.14. The advertising system 110 optionally proceeds on from step 6.30 to step 6.32 and to apply some or all of an information decrypted from the encrypted payload PAY.01-PAY.N received in step 6.26, wherein the optional application of information of step 6.32 may be performed as directed by a user or by an automated action of the advertising system software 110.5W.

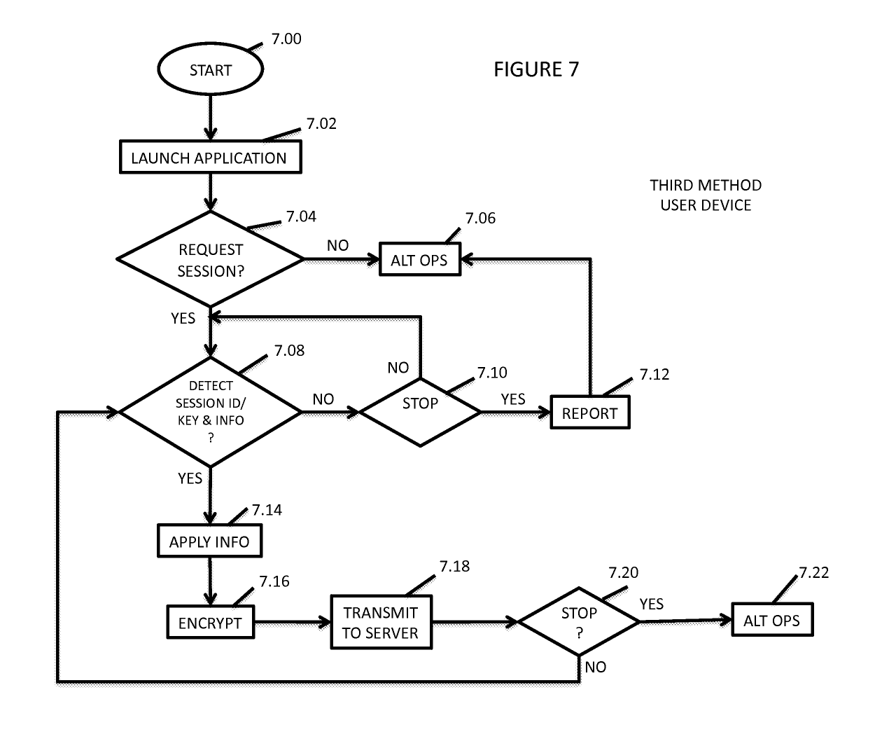

Referring now generally to the Figures and particularly to FIG. 7, FIG. 7 is a flowchart of operations of the user device 120 that presents optional aspects of the third method. In optional step 7.02 the user device 120 launches the native user device software application UD.SW that enables the formation of the second channel B. In optional step 7.04 a user of the user device 120 directs the user device 120 to initiation a reception of the rendering by the advertising system 110 of QR code image 110.QR. When the user device 120 does not receive a request to initiate of communications session with the advertising system 110 in optional step 7.04, the user device 120 proceeds on to step 7.06 and to perform alternate computational operations. It is understood that the user device 120 may subsequently return to an additional execution of step 7.02 as directed by the user of by an automated process.

The user device 120 may either proceed directly from step 7.02 or from step 7.04 to step 7.08 to determine whether the QR code image 110.QR is detected by input of the user device digital camera 120.CAM and analysis of a QR software 120.QRSW of the user device 120. When the user device 120 does not detect the QR image 110.Q that includes an encoded a session identifier 150A-150N and an encoded encryption key KEY.01-KEY.N in step 7.08, the user device 120 proceeds from step 7.08 to step 7.10. The user device 120 determines in step 7.10 whether to proceed to step 7.12 and to report to the user via the user device display 120.DIS of this failure to detect a relevant QR image 110.QR, or in the alternative to return to another execution of step 7.08.

When the QR image 110.QR is detected by the user device 120 in step 7.08, the user device 120 applies any contextual information read by the QR reader software 120.QRSW to select information INFO.01-INFO.02 in step 7.14 and encrypts the selected information INFO.01-INFO.02 in step 7.16 to generate an encrypted payload PAY.01-PAY.N by application of the encryption key KEY.01-KEY.N received from the QR code image 110.QR detected in step 7.08.

In step 7.18 the 120X formats a user message UMSG.01-UMSG.N that includes both the encrypted payload PAY.01-PAY.N encrypted in step 7.16 and the session identifier 150A-150N detected from the QR code image 110.QR in step 7.08 to the server 130. The user device 120 determines in step 7.20 whether to proceed on to either (a.) an additional performance of step 7.08; or (b.) to step 7.22 and to cease execution of the user device software 120.5W and to perform alternate additional computational operations. It is understood that user device 120 may subsequently proceed from step 7.22 to an additional execution of step 7.02 as directed by an automated process or by a direction of a human system administrator.

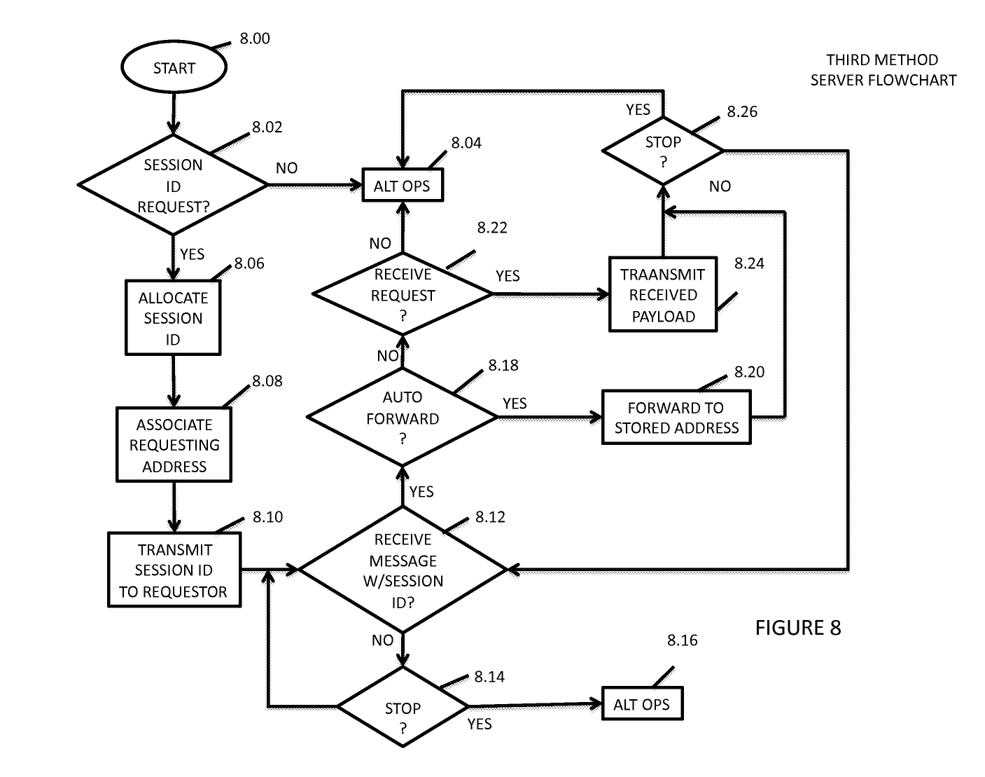

Referring now generally to the Figures and particularly to FIG. 8, FIG. 8 is a flowchart of operations of the server 130 that presents optional aspects of the third method. The server 130 determines in step 8.02 whether it has received a request message RMSG.01-RMSG.N for a session identifier 150A-150N via the network 140, and proceeds on to step 8.04 to perform alternate computational operations when no request for a session identifier 150A-150N is received in step 8.02. In the alternative, when the server 130 detects a request message RMSG.01-RMSG.N for a session identifier 150A-150N via the network 140 in step 8.02. the server 130 allocates a session identifier 150A-150N in step 8.06 and optionally associates a requesting address ADDR.REQ of the request message RMSG.01-RMSG.N detected in step 8.02 with the session identifier 150A-150N allocated in optional step 8.08 in a session record SREC.01-SREC.N. The server 130 then transmits the session identifier 150A-150N allocated in step 8.06 to the requestor address ADDR.REQ of the request message RMSG.01-RMSG.N detected in step 8.02.

The server 130 determines in step 8.12 whether it has received a user message UMSG.01-UMSG.N containing a session identifier 150A-150N via the network 140. When the server 130 determines in step 8.12 that it has not detected a receipt of a user message UMSG.01-UMSG.N containing a session identifier 150A-150N, the server 130 proceeds on to step 8.14 to determine whether to repeat additional executions of step 8.12 or to proceed on to alternate computational operations of step 8.16. It is understood that server 130 may subsequently proceed from step 8.16 to an additional execution of step 8.02 as directed by an automated process or by a direction of a human system administrator.

In the alternative, when the server 130 in step 8.12 detects a receipt of a user message UMSG.01-UMSG.N containing a session identifier 150A-150N, the server 130 in optional determines in step 8.18 whether to forward the payload PAY.01-PAY.N of the UMSG.01-UMSG.N received and detected in step 8.12 by the server 130 to a requester address REQ.ADDR previously associated in a session record SREC.01-SREC.N with the session identifier 150A-150N included in the instant user message UMSG.01-UMSG.N received in step 8.12. The server 130 may elect in step 8.18 to proceed to step 8.20 and forward the payload PAY.01-PAY.N of the UMSG.01-UMSG.N received and detected in step 8.12 to the associated requester address ADDR.REQ.

The server 130 determines in step 8.22 whether it has received a request message RMSG.01-RMSG.N referencing the session identifier 150A-150N of the user message UMSG.01-UMSG.N received in step 8.12 and, if a request message RMSG.01-RMSG.N referencing the session identifier 150A-150N of the user message UMSG.01-UMSG.N received in step 8.12 is detected in step 8.22, the server 130 proceeds from step 8.22 to step 8.24 and forwards the payload PAY.01-PAY.N of the user message UMSG.01-UMSG.N received in step 8.12 to a requester address ADDR.REQ of the request message RMSG.01-RMSG.N detected in step 8.22. In the alternative, when the server 130 does not detect a request message RMSG.01-RMSG.N in step 8.22, the server 130 proceeds onto step 8.04.

The server 130 proceeds from either step 8.20 or step 8.24 to step 8.26 and to determine whether to proceed to either step 8.04 or an additional execution of step 8.12.

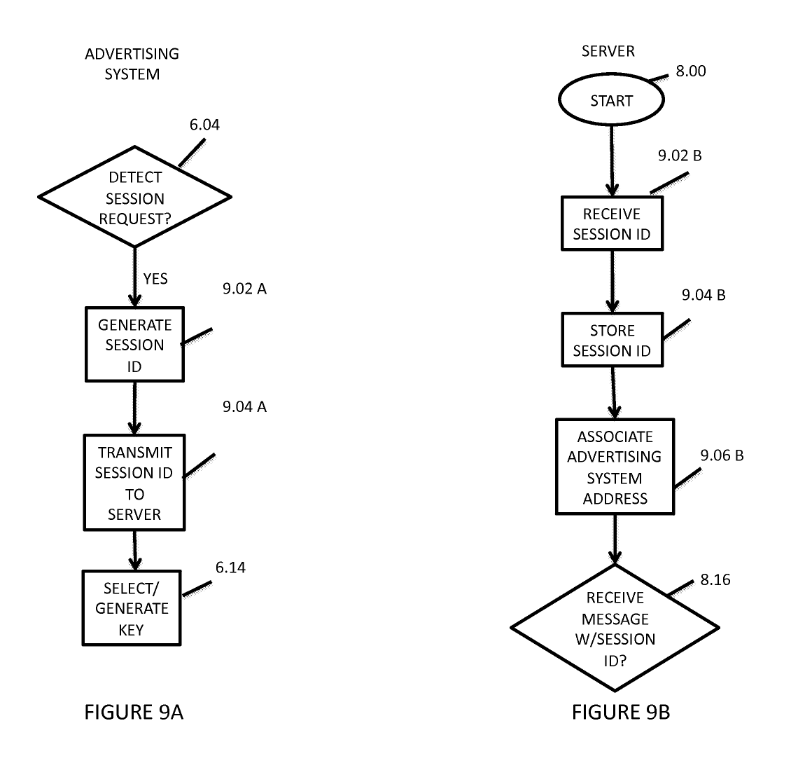

Referring now generally to the Figures and particularly to FIGS. 9A, and 9B, FIG. 9A is a flowchart of operations of the advertising system 110 that presents a fourth alternate preferred embodiment of the invented method (hereinafter, “the fourth method”), wherein the advertising system 110 generates or allocates a session identifier 150A-150N in step 9.02A and transmits the instant session identifier 150A-150N to the server 130 in step 9.04A.

FIG. 9B is a flowchart of additional optional aspects of operations of the server 130 in accordance with the fourth method, wherein the server 130 receives a session identifier 150A-150N from the advertising system 110 in step 9.02B, stores the received session identifier 150A-150N in step 9.04B, and optionally associates the advertising system 110 with the received session identifier 150A-150N in step 9.06B.

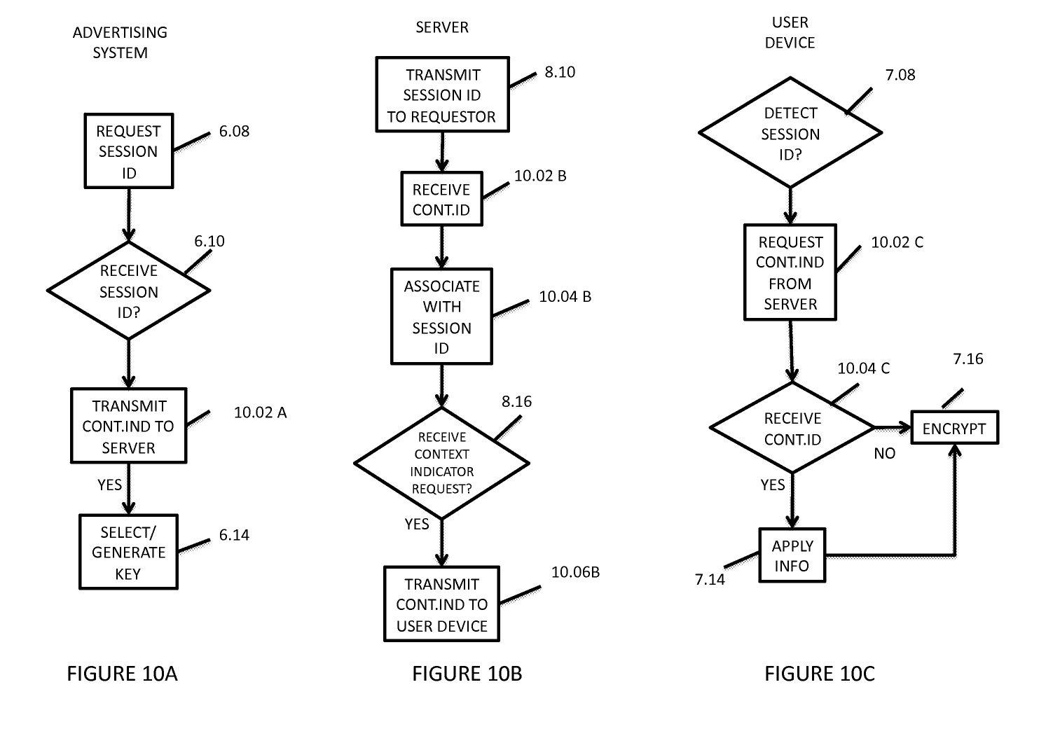

Referring now generally to the Figures and particularly to FIGS. 10A, 10B and 10C, FIG. 10A is a flowchart of operations of the advertising system 110 that presents a fifth alternate preferred embodiment of the invented method (hereinafter, “the fifth method”), wherein the advertising system 110 transmits the first contextual information INFO.01 and/or additional data DATA.01 to the server 130 via the network 140 in step 10.02A.

FIG. 10B is a flowchart of additional optional aspects of operations of the server 130 in accordance with the fifth method, wherein the server 130 receives the first contextual information INFO.01 and/or first additional data DATA.01 from the advertising system 110 via the network 140 in step 10.02B. The server 130 optionally associates the advertising system 110 with the received first contextual information INFO.01 and/or first additional data DATA.01 in step 10.04B, and transmits the first contextual information INFO.01 and/or additional data DATA.01 to the user device 120 in step 10.06B.

FIG. 10C is a flowchart of additional optional aspects of operations of the user device 120 in accordance with the fifth method, wherein the user device 120 request the first contextual information INFO.01 and/or first additional data DATA.01 from the server 130 via the network 140 in step 10.02C and receives the first contextual information INFO.01 and/or first additional data DATA.01 from the server 130 via the network 140 in step 10.04C.

Referring now generally to the Figures and particularly to FIG. 11, FIG. 11 is a flowchart of additional optional aspects of operations of the user device 120 in accordance with a sixth alternate preferred embodiment of the invented method, wherein the user device 120 receives contextual information INFO.01-INFO.N and/or additional data either (a.) from the advertising system 110 via the channel B, or (b.) from the server 130 via channel A. The user device 120 determines if a session identifier 150A-150N and an encryption key KEY.01-KEY.N have been received from the advertising system 110, and if a reception of a session identifier 150A-150N and an encryption key KEY.01-KEY.N is detected in step 7.04, the user device 120 proceeds on to step 12.02. In the alternative, if the user device 120 does not detects a reception of a session identifier 150A-150N and an encryption key KEY.01-KEY.N in step 7.04, the user device 120 proceeds on to step 7.06.

In step 12.02 the user device 120 determines whether at least one context indicator CONT.IND.01-CONT.IND.N has been received from the advertising system 110 via the channel B, and when the user device 120 determines that it has at least one context indicator CONT.IND.01-CONT.IND.N from the advertising system 110 via the channel B, proceeds on to step 12.04 and to search the user device database management system 120.DBMS to find any context indicator records CONT.REC.01-CONT.REC.N that reference the context indicator CONT.IND.01-CONT.IND.N received from the advertising system 110 via the channel B.

When the user device 120 determines in step 12.06 that a match is found between one or more context indicator records CONT.REC.01-CONT.REC.N and the context indicator CONT.IND.01-CONT.IND.N received from the advertising system 110 via the channel B, the user device 120 proceeds on to step 12.08 and to include and encrypt some or all content of the context indicator records CONT.REC.01-CONT.REC.N that reference the instant context indicator CONT.IND.01-CONT.IND into the payload PAY.01-PAY.N. The user device 120 then transmits the newly generated payload PAY.01-PAY.N in association with the session identifier 150A-150N detected as received by the 120X in step 7.04 to the server 130 in step 7.08.

Referring now back to step 12.02, when the user device 120 determines that no context indicator CONT.IND.01-CONT.IND.N has been detected in step 12.02 as having been received from the advertising system 110 via the channel B, the user device 120 proceeds on to step 12.10 and formats and transmits a request message to the server 130 that is communicated via the channel A, wherein the request message references the session identifier 150A-150N detected as received in step 7.04 and requests any payloads PAY.01-PAY.N associated with the instant session identifier 150A-150N from the server 130. When the user device 120 detects a receipt of a context indicator CONT.IND.01-CONT.IND.N in a response message from the server 130 sent via the channel A that includes at least one context indicator CONT.IND.01-CONT.IND.N, in step 12.12, the user device 120 proceeds on to step 12.04. When the user device 120 fails to detect a receipt of a context indicator CONT.IND.01-CONT.IND.N in a response message from the server 130 that includes at least one context indicator CONT.IND.01-CONT.IND.N, in step 12.12, the user device 120 proceeds on to optional step 12.14 and to this lack of receipt of an associated context indicator CONT.IND.01-CONT.IND.N via user device display screen 120.DIS. The user device 120 proceeds from either step 12.12 or step 12.14 to step 7.06.

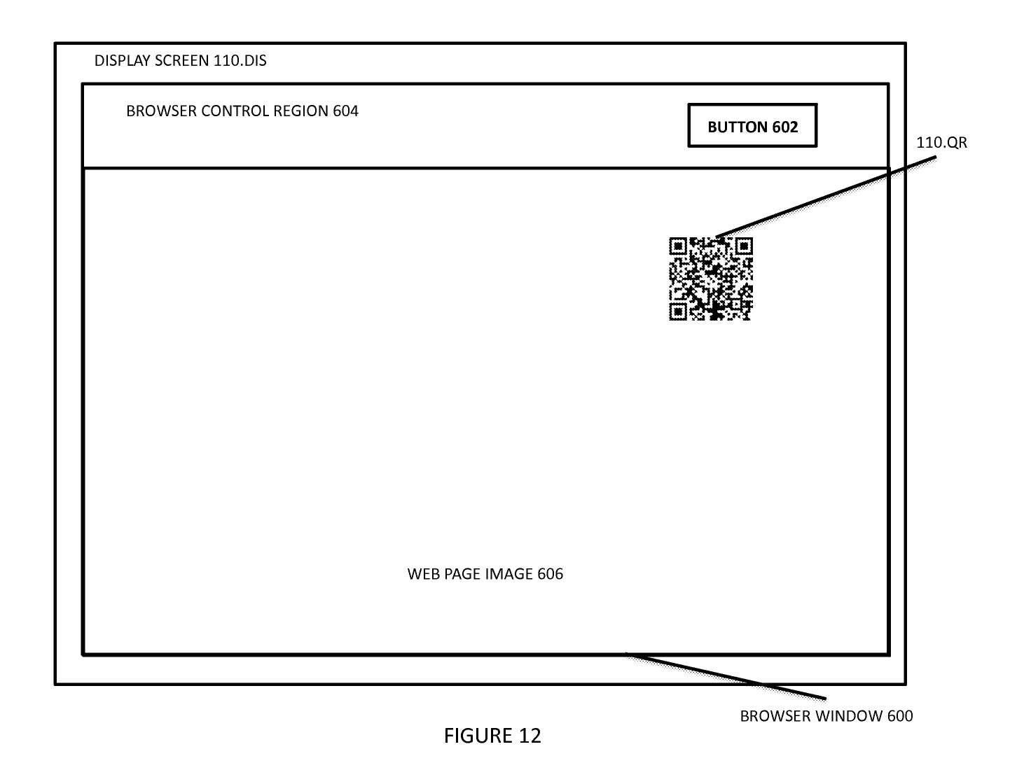

Referring now generally to the Figures and particularly to FIG. 12, FIG. 12 is a depiction of the webpage image 606 displayed in the display screen 110.DIS of the advertising system 110. The service activation button 602 and the QR image 110.QR are also presented in FIG. 11

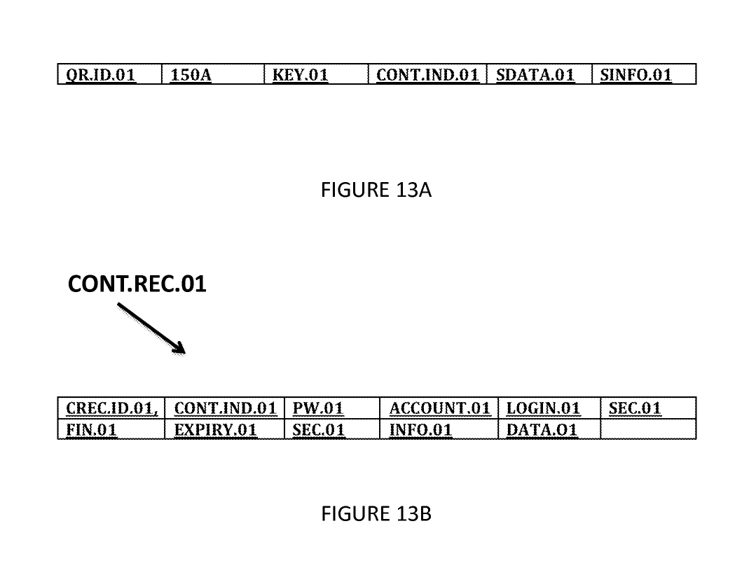

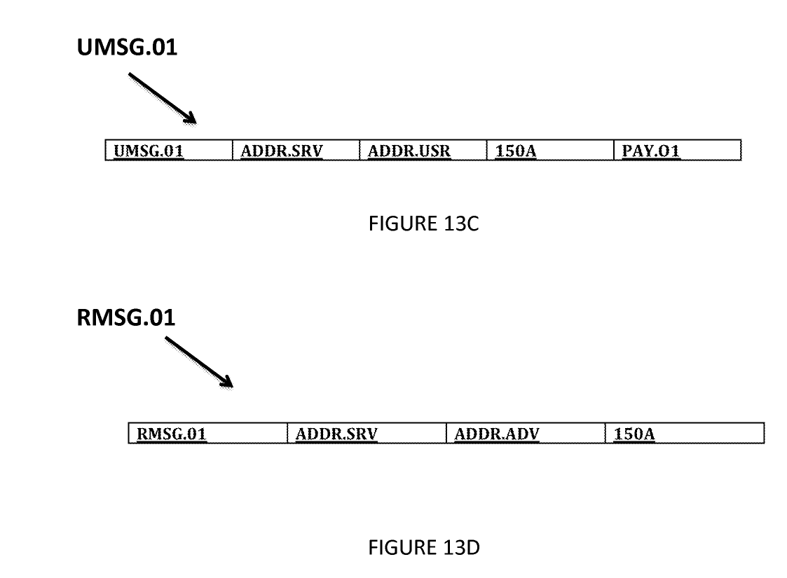

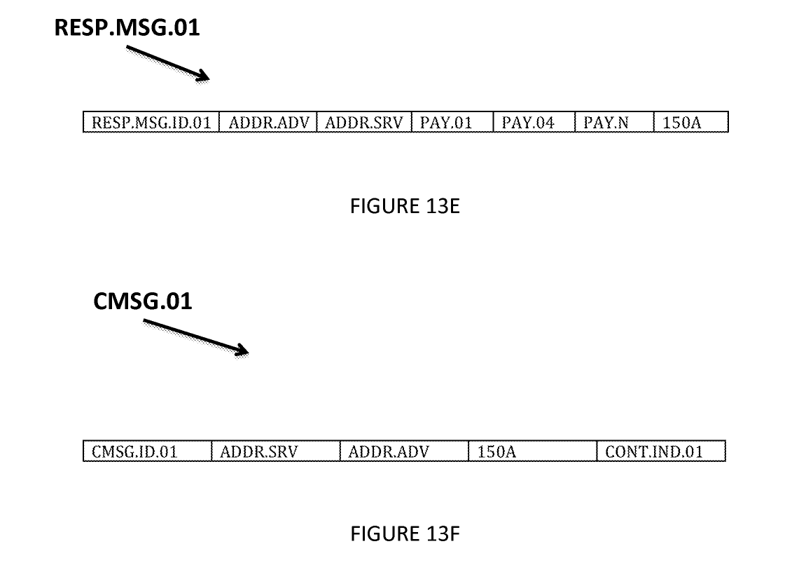

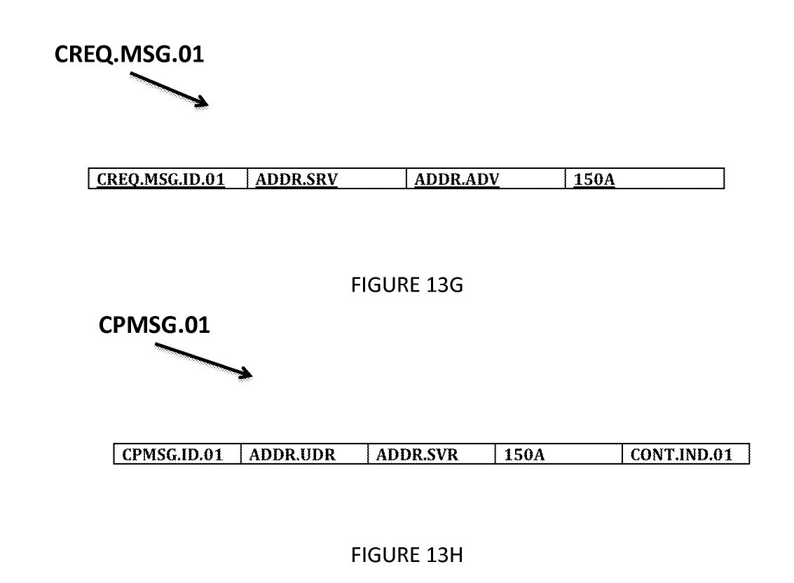

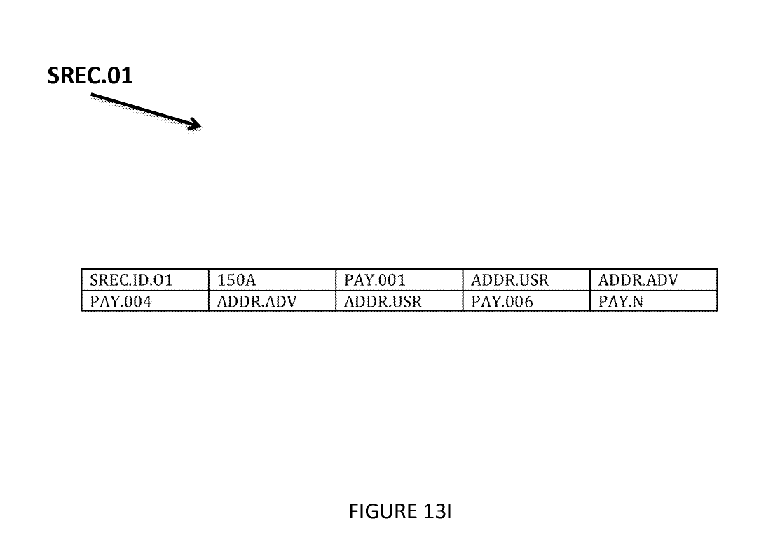

Referring now generally to the Figures and particularly to FIG. 13A, FIG. 13A is a representation of certain informational elements 12A.01 of an exemplary first QR record 110.QRREC that defines the exemplary first quick response code image 110.QR displayed in the display screen 110.DIS of the advertising system 110. This first QR information elements 12A.00 include the first session identifier 150A, the first encryption key KEY.01 and optionally (a.) an exemplary first context indicator CONT.IND.01, (b.) an additional first system data SDATA.01, and/or (c.) an additional first system information SDATA.01-SDATA.N. The first QR code image 110.QR is rendered in step 3.10, step 6.18.

Referring now generally to the Figures and particularly to FIG. 13B, FIG. 13B is a representation of an exemplary first context record CONT.REC.01 stored by the user device 120, wherein information is associated with a first context indicator CONT.IND.01 as stored within the user device. The first exemplary context record CONT.REC.01 includes a first context record identifier CREC.ID.01, the first context indicator CONT.IND.01, and associated information, such as a first password PW.01, a first account name ACCOUNT.01, a first login name LOGIN.01, a first financial account number FIN.01, a first expiry date EXPIRY.01 that is preferably associated with the first financial account number FIN.01, a first additional security code SEC.01 that is preferably associated with the first financial account number FIN.01, a first additional data DATA.01 and a first additional information INFO.01. The first additional data DATA.01 and/or a first additional information INFO.01 may include a personal identifier, a media file and/or a payment authorization.

The first payload PAY.01 may include various information in an encrypted form, to include the first password PW.01, the first account name ACCOUNT.01, the first login name LOGIN.01, the first financial account number FIN.01, the first expiry date EXPIRY.01, the first additional security code SEC.01, the first additional data DATA.01 the first additional information INFO.01, a personal identifier, a media file and/or a payment authorization.

It is understood that receipt by the user device 110 of the context indicator CONT.IND.01 enables the user device to reference data and information referenced by, or included within, the first exemplary context record CONT.REC.01 and subsequently select, encrypt and include the data and information referenced by or included within the first exemplary context record CONT.REC.01 within the first payload PAY.01. e.g., the first password PW.01, the first account name ACCOUNT.01, the first login name LOGIN.01, the first financial account number FIN.01, the first expiry date EXPIRY.01, the first additional security code SEC.01 the first additional information INFO.01 and the first additional data DATA.0.

The first payload PAY.01 is then transmitted to the server 130 in association with the first session identifier 150A in steps 2.06, 4.10 and 7.18. It is understood that other content records CONT.REC.01-CONT.REC.N specify and include other context indicators CONT.REC.01-CONT.REC.N, other passwords PW.01-PW.N, other account information, other financial account information, other expiry dates, other security codes, other information and other data.

Referring now generally to the Figures and particularly to FIG. 13C, FIG. 13C is a representation of an exemplary first user message UMSG.01 as formatted and transmitted by the user device 120 via the first channel A to the server 130. The first user message UMSG.01 includes a first user message identifier UMSG.ID.01, the server network address ADDR.SRV as a destination address, a network address of the user device ADDR.USR as a sender address, the first session identifier 150A, and the first encrypted payload PAY.01. It is understood that other user messages UMSG.02-UMSG.N specify and include other session identifiers 150B-150N, other encrypted payloads PAY.01-PAY.N and other network addresses. The first user message UMDG.01 is transmitted via the Channel A from the user device 120 to the server 130 in steps 2.06, 4.10, and 7.18.

Referring now generally to the Figures and particularly to FIG. 13D, FIG. 13D is a representation of an exemplary first request message RMSG.01 whereby the advertising system 110 requests one or more encrypted payloads PAY.01-PAY.N FROM the server 130 that are associated with the exemplary first session identifier 150A. The first request message RMSG.01 includes a first request message identifier RMSG.ID.01, the server network address ADDR.SRV as a destination address, an advertising system network address ADDR.ADV of the advertising system 110 as a sender address, and the first session identifier 150A. It is understood that other request messages RMSG.02-RMSG.N specify and include other session identifiers 150B-150N and other network addresses. The first request message RMSG.01 is transmitted from the advertising system 110 to the server 130 optionally in step 3.12, optionally in step 6.24.

Referring now generally to the Figures and particularly to FIG. 13E, FIG. 13E is a representation of an exemplary first response message RESP.MSG.01 whereby the server 130 transmits a first payload PAY.01 associated with the exemplary first session identifier 150A to a network address ADDR.ADV of the advertising system 110. The server 130 transmits the first response message RESP.MSG.01 to the advertising system in step 5.16.

The first request response message RESP.MSG.01 includes a first response message identifier RESP.MSG.ID.01, advertising system network address ADDR.ADV of the advertising system 110 as a destination address, the network address ADDR.SRV of the server 130 as a sender address, at least one encrypted payload PAY.01-PAY.N that is associated with the first session identifier 150A by the server 130, and optionally the first session identifier 150A. It is understood that other request response messages RESP.MSG-01-RESP.MSG.N specify and include other session identifiers 150B-150N, other encrypted payloads PAY.001-PAY.N and other network addresses.

Referring now generally to the Figures and particularly to FIG. 13F FIG. 13F is a representation of an exemplary first context message CMSG.01 whereby the advertising system 110 provides the exemplary first context indicator CONT.IND.01 to the server 130. The first context message CMSG.01 includes a first context message identifier CMSG.ID.01, the server network address ADDR.SRV as a destination address, the advertising system network address ADDR.ADV of the advertising system 110 as a sender address, the first session identifier 150A, and the first context indicator CONT.IND.01. It is understood that other context messages CMSG.02-CMSG.N specify and include other session identifiers 150B-150N, other context indicators CONT.IND.02-CONT.IND.N and other network addresses. The advertising system 110 provides the exemplary first context indicator CONT.IND.01 to the server 130 in step 10.02 and to the user device 120 in step 10.06B.

Referring now generally to the Figures and particularly to FIG. 13G, FIG. 13G is a representation of an exemplary first context request message CREQ.MSG.01 wherein the user device 120 requests the first context indicator CONT.IND.01 from the server 130. The first context request message CREQ.MSG.01 includes a first context request message identifier CREQ.MSG.ID.01, the server network address ADDR.SRV as a destination address, the user device network address ADDR.USR as a sender address, and the first session identifier 150A. It is understood that other context request messages CREQ.MSG.02-CREQ.MSG.N specify and include other session identifiers 150B-150N and other network addresses. The user device 120 transmits the first context request message CREQ.MSG.01 to the server 130 and thereby requests the first context indicator CONT.IND.01 from the server 130 in step 10.02C.

Referring now generally to the Figures and particularly to FIG. 13H, FIG. 13H is a representation of an exemplary first context indicator provision message CPMSG.01 wherein the server 130 provides the first context indicator CONT.IND.01 to the user device 120. The first context indicator provision message CREQ.MSG.01 includes a first context provision message identifier CPMSG.ID.01, the server network address ADDR.SRV address as a sender address, the first session identifier 150A, and the first context indicator CONT.IND.01. It is understood that other context indicator provision messages CPMSG.01-CPSMG.N specify and include other session identifiers 150B-150N, other context indicators CONT.IND.02-CONT.IND.N and other network addresses. The server 130 transmits the first context indicator provision message CPMSG.01 to the user device 120 in step 10.06B.

Referring now generally to the Figures and particularly to FIG. 13I, FIG. 13I is a representation of an exemplary first session record SREC.01 that associates one or more payloads PAY.01-PAY.N and optionally one or more network addresses with the first session identifier 150A. The first session record SREC.01 includes (a.) a first session record identifier SREC.ID.01, (b.) the first session identifier 150A, (c.) the first encrypted payload PAY.001, (d.) the sender address of the first encrypted payload PAY.001, i.e., the user network address ADDR.USR, (e.) the recipient address of the first encrypted payload PAY.001, i.e., the advertising system network address ADDR.ADV, (f.) the fourth encrypted payload PAY.004, (g.) the sender address of the fourth encrypted payload PAY.004, i.e., the advertising system network address ADDR.ADV, (h.) the recipient address of the fourth encrypted payload PAY.004, i.e., the user device network address ADDR.USR; and (i.) the nth encrypted payload PAY.N. It is understood that other session records SREC.02-SREC.N specify and include other session identifiers 150B-150N, other encrypted payloads PAY.001-PAY.N and other network addresses.

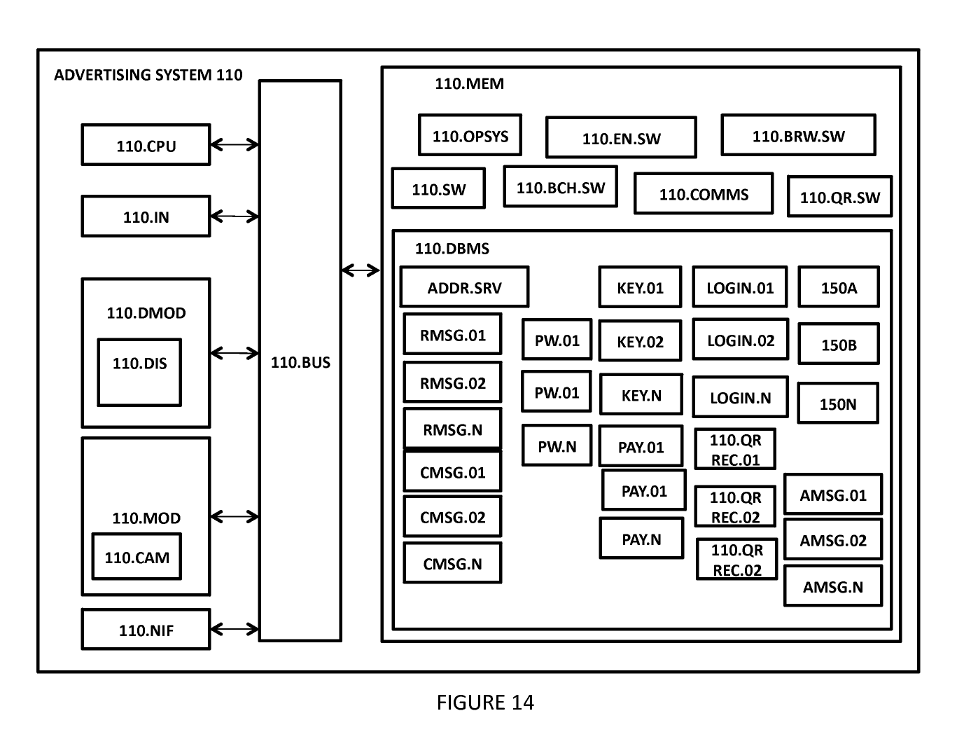

Referring now generally to the Figures and particularly to FIG. 14, FIG. 14 is a schematic block diagram of the advertising system 110. The advertising system 110 comprises a system central processing unit 110.CPU that is bi-directionally communicatively coupled by a system internal communications bus 110.BUS to a user input module 110.1N, a visual display module 110.DMOD comprising the system display screen 110.DIS, a system channel B module 110.MOD, a system network interface module 110.NIF and a system memory 110.MEM.

The system memory 110.MEM includes a system operating system 110.OPSYS, an encryption/decryption software module 110.EN.SW, a system browser software 110.BRW.SW, a system network communications software 110.COMMS, a QR code rendering and encoding software 110.QR.SW, a system software 110.5W, and a system databases management system 110.DBMS. The encryption/decryption software 110.EN.SW enables the advertising system 110 to encrypt and/or decrypt payloads in steps 2.04, 3.20 and 6.30. The system browser software 110.BRW.SW enables the advertising system 110 to browse World Wide Web via the network 14 as directed by a user and render the first webpage image 606 and activation button 602 on the system display screen 110.DIS. The channel B software110.BCH.SW enables the advertising system 110 to communicate over the channel B via the system B channel module 110.MOD. The system network communications software 110.COMMS enables the advertising system 110 to communicate with the channel A and the network 140 via the system network interface 110.NIF. The QR code rendering and encoding software 110.QR.SW enables the advertising system to encode and render by means of the advertising display screen 110.DIS one or more session identifiers 150A-150N, one or more encryption keys KEY.01-KEY.N, one or more context indicators CONT.IND.01-CONT.IND.N, and/or other information into a QR code image, such as the representative first QR code image 606, for display by the advertising system display screen 110.DIS. The system software 110.5W enables the advertising system 110 to execute the various aspects of the invented method as disclosed herein.

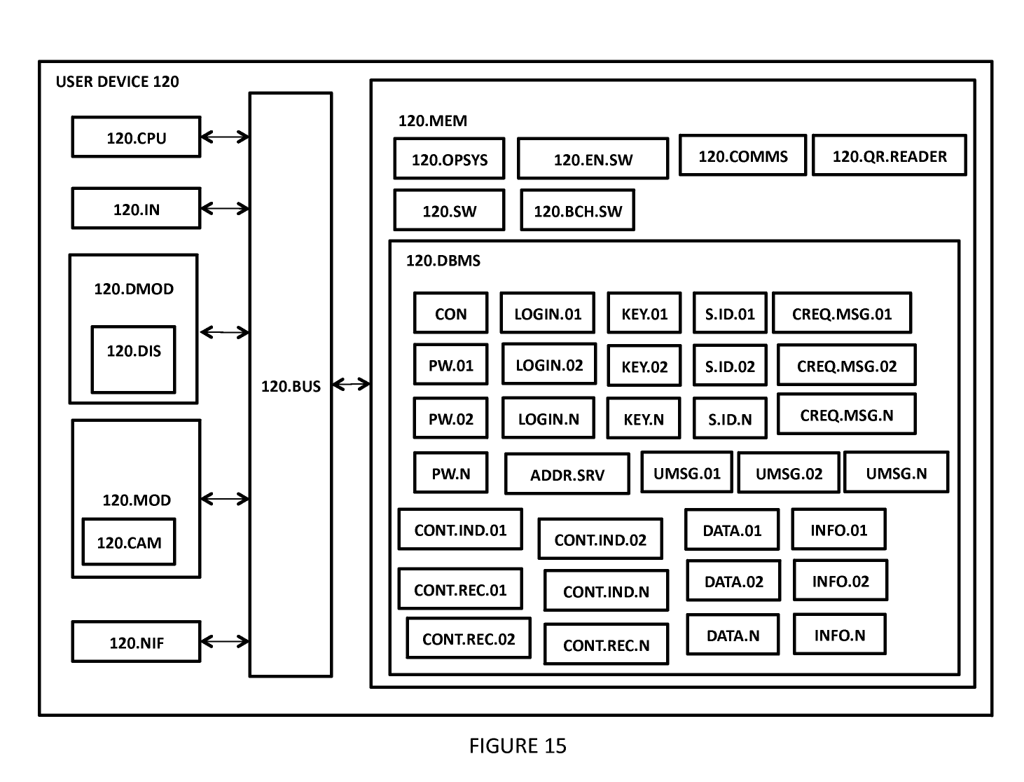

Referring now generally to the Figures and particularly to FIG. 15, FIG. 15 is a schematic block diagram of the user device 120. The user device 120 comprises a device central processing unit 120.CPU that is bi-directionally communicatively coupled by a device internal communications bus 120.BUS to a user input module 120.1N, a visual display module 120.DMOD having a device display screen 120.DIS, a device channel B module 110.MOD, a device network interface module 110.NIF and a device memory 120.MEM.

The device memory 120.MEM includes a device operating system 120.OPSYS, an encryption/decryption software module 120.EN.SW, a device network communications software 120.COMMS, a device software 120.5W, a QR reader software 120.QR.READER and a device databases management device 120.DBMS. The encryption/decryption software 120.EN.SW enables the user device 120 to encrypt and/or decrypt payloads in steps 2.06, 4.08 and 7.16. The QR reader software 120.QR.READER enamels the user device 110 to extract information from the QR code image 110.QR, wherein such information may include a session identifier 150A-150N, an encryption key KEY.01-KEY.N and/or other information.

The device channel B software 120.BCH.SW enables the user device 120 to communicate over the channel B via the device B channel module 120.MOD. The device network communications software 120.COMMS enables the user device 120 to communicate with the channel A and the network 140 via the device network interface module 120.NIF. The device software 120.5W enables the user device 120 to execute the various aspects of the invented method as disclosed herein.

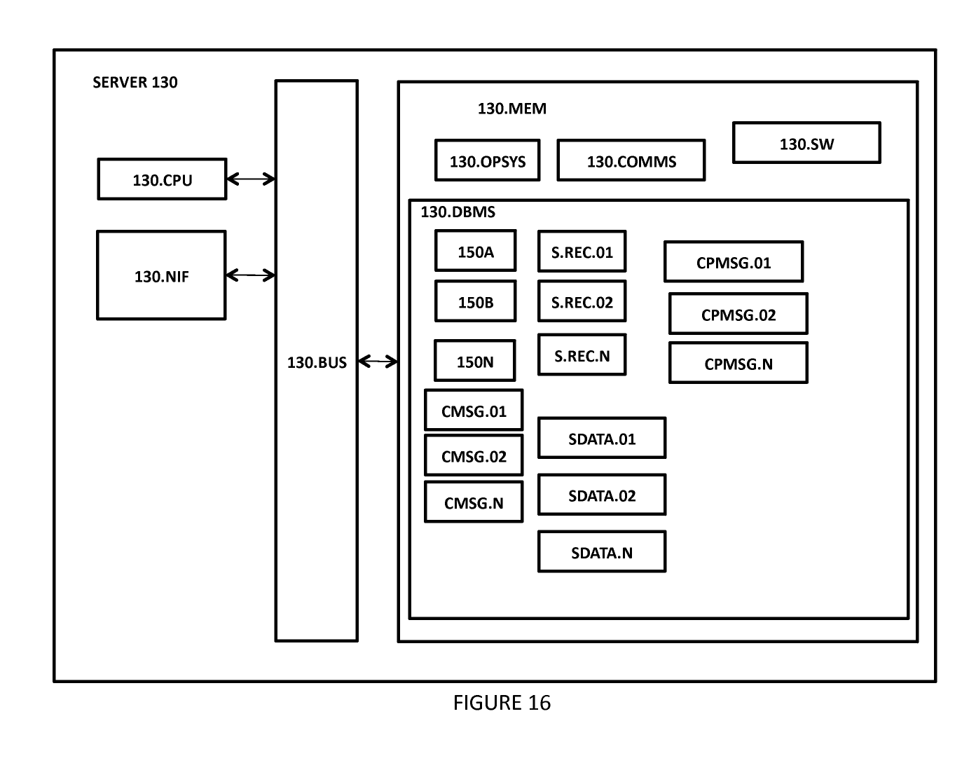

Referring now generally to the Figures and particularly to FIG. 16, FIG. 16 is a schematic block diagram of the server 130. The server 130 comprises a server central processing unit 130.CPU that is bi-directionally communicatively coupled by a server internal communications bus 130.BUS a server network interface module 130.NIF and a server memory 130.MEM.

The server memory 130.MEM includes a server operating system 130.OPSYS, a server network communications software 130.COMMS, a server software 130.5W and a server databases management server 130.DBMS.

The server network communications software 130.COMMS enables the server 130 to communicate with the channel A, the network 140, the advertising system 110 and the user device 120 via the server network interface module 130.NIF. The server software 130.5W enables the server 130 to execute the various aspects of the invented method as disclosed herein.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

I claim:

1. A computer-implemented method comprising:
a. an advertising system comprising a rendering module allocating a session identifier, the session identifier available at a service provider server;
b. the advertising system rendering the session identifier and an encryption key by means of the rendering module;
c. the advertising system receiving an encrypted payload via an electronics communications network; and
d. the advertising system decrypting the encrypted payload by application of the encryption key.

2. The computer-implemented method of claim 1, wherein advertising system and service provider system are bi-directionally communicatively coupled with an electronics communications network and the rendering of the encryption key is isolated from the electronics communications network.

3. The computer-implemented method of claim 1, wherein the advertising system request communication of the encrypted payload from the service provider system.

4. The computer-implemented method of claim 1, wherein the encrypted payload is received in an electronic message, the electronic message further comprising the session identifier.

5. The computer-implemented method of claim 1, wherein the encrypted payload is received in an electronic message associable by the advertising system with the session identifier.

6. The computer-implemented method of claim 1, further comprising the advertising system originating the session identifier and the advertising system communicating the session identifier to the service provider server.

7. The computer-implemented method of claim 1, further comprising the server provider system originating the session identifier and the service provider system communicating the session identifier to the advertising system.

8. The computer-implemented method of claim 1, further comprising the advertising system additionally rendering a contextual information in association with the rendering of the session identifier and the encryption key.

9. The computer-implemented method of claim 1, further comprising the advertising system additionally communicating a contextual information to the service provider in association with the session identifier.

10. The computer-implemented method of claim 1, wherein the rendering module is adapted to render communication of the session identifier and the encryption key to a client device by light wave transmission.

11. The computer-implemented method of claim 1, wherein the rendering module is adapted to affect communication of the session identifier and the encryption key to a client device by sound wave transmission.

12. The computer-implemented method of claim 1, wherein the encrypted payload further comprises data selected from the data group consisting of an information, a media file, a password, an account identifier, a financial account identifier, a personal identifier and a payment authorization.

13. A computer-implemented method comprising:
a. a network-enabled client device compromising a receiving module receiving a rendering of a session identifier and an encryption key via the receiving module;
b. the client device generating an encrypted payload by application of the encryption key to a client information available to the client device; and
c. the client device communicating the encrypted payload to a service provider system in association with the session identifier via the electronics communications network.

14. The computer-implemented method of claim 13, wherein the session identifier and the encrypted payload are communicated from the client device in a same electronic message.

15. The computer-implemented method of claim 13, wherein the client information includes client data selected from the client data group consisting of an information, a media file, a password, an account identifier, a financial account identifier, a personal identifier, and a payment authorization.

16. The computer-implemented method of claim 12, further comprising the client device receiving a contextual information by means of the receiving module and the client device selecting the client information at least partly on the basis of the contextual information.

17. The computer-implemented method of claim 12, further comprising the client device receiving a contextual information by means of the electronics communications network and the client device selecting the client information at least partly on the basis of the contextual information.

18. The computer-implemented method of claim 17, wherein the client device requests the contextual information from the service provider system in reference to the session identifier.

19. A computer-implemented method comprising:
a. a service provider system allocating a session identifier, the session identifier available at an advertising system;
b. the service provider system receiving an encrypted payload via an electronics communications network;
c. the service provider system associating the encrypted payload with the session identifier; and
d. the service provider system communicating the encrypted payload to the advertising system via the electronics communications network to the advertising system.

20. The method of claim 19, wherein the service provider system originates the session identifier.

21. The method of claim 19, wherein the service provider system associates the session identifier with the advertising system and automatically forwards the encrypted payload to the advertising system.

22. The method of claim 19, wherein the service provider system associates the session identifier with a contextual information and communicates the contextual information in response to a query message associable with the session identifier.
